(19) United States
(12) Patent Application Publication
(10) Pub. No.: US 2024/0385939 A1
(43) Pub. Date: Nov. 21, 2024

(54) METHODS, SYSTEMS, AND COMPUTER PROGRAM PRODUCTS FOR DATA INDEXING AND EVALUATION IN DISTRIBUTED COMPUTING ENVIRONMENTS

(71) Applicant: Invesco Holding Company (US), Inc., Atlanta, GA (US)

(72) Inventors: Jerry Clinton HARRIS, II, Atlanta, GA (US); Paul Thomas BRUNSWICK, Nokomis, FL (US)

(73) Assignee: Invesco Holding Company (US), Inc., Atlanta, GA (US)

(21) Appl. No.: 18/667,400

(22) Filed: May 17, 2024

Related U.S. Application Data
(60) Provisional application No. 63/467,173, filed on May 17, 2023.

(51) Int. Cl. G06F 11/34

(52) U.S. Cl. CPC G06F 11/3447; G06F 11/3438

(57) ABSTRACT

Systems, methods, and computer program products are provided for data indexing and evaluation in distributed computing environments. An example computer-implemented method includes receiving a request for data evaluation associated with a first user and generating one or more user input objects based upon the request that are associated with one or more evaluation categories. The computer-implemented method further includes causing presentation of the one or more user input objects to the first user and receiving one or more user inputs from the first user via the one or more user input objects. The computer-implemented method also includes determining one or more evaluation attributes associated with the first user based on the received one or more user inputs and generating an evaluation output indicative of a performance of the first user with respect to at least the one or more evaluation categories.

### CROSS-REFERENCE TO RELATED APPLICATIONS

This application claims priority to U.S. Provisional Application No. 63/467,173, filed May 17, 2023, the content of which application is hereby incorporated by reference herein in its entirety.

### TECHNOLOGICAL FIELD

Embodiments of the present disclosure relate generally to distributed computing environments, and, more particularly, to the indexing and evaluation of user related data generated in these distributed computing environments.

### BACKGROUND

Computing environments may be formed by various distributed and communicably coupled computing components, devices, and/or the like that may be further associated with various users (e.g., via user devices). These users may access applications or other functionality that is provided by these computing environments and generate user data during these interactions. Through applied effort, ingenuity, and innovation, many of the problems associated with conventional user related data indexing and evaluation systems have been solved by developing solutions that are included in embodiments of the present disclosure, many examples of which are described in detail herein.

### BRIEF SUMMARY

Embodiments of the present disclosure provide for methods, systems, apparatuses, and computer program products for data indexing and evaluation. An example computer-implemented method may include receiving a request for data evaluation associated with a first user and generating one or more user input objects based upon the request where the one or more user input objects are associated with one or more evaluation categories. The computer-implemented method may further include causing presentation of the one or more user input objects to the first user, receiving one or more user inputs from the first user via the one or more user input objects, and determining one or more evaluation attributes associated with the first user based on the received one or more user inputs. The computer-implemented method may also include generating an evaluation output indicative of a performance of the first user with respect to at least the one or more evaluation categories.

In some embodiments, the request for data evaluation may further include one or more first user characteristics of the first user. In such an embodiment, generating the one or more user input objects may be further based upon the one or more first user characteristics.

In some further embodiments, the one or more evaluation categories may be selected at least partially based upon the one or more first user characteristics.

In some embodiments, the computer-implemented method may further include determining one or more presentation parameters that define a configuration by which the user input objects are presented to the first user.

In some further embodiments, the one or more presentation parameters may include a presentation order defining an order in which the one or more user input objects are presented to the user.

In some embodiments, the one or more user input objects may further include at least a first user input object presented to the first user at a first time and a second user input object presented to the first user at a second time. In such an embodiment, the method may further include determining the first time and the second time based at least in part upon the user input from the first user provided via the first user input object.

In some further embodiments, each of the first user input object and the second user input object may be associated with a first evaluation category.

In some embodiments, the one or more user input objects further include at least a first user input object associated with a first evaluation category and a second user input object associated with a second evaluation category.

In some embodiments, determining the one or more evaluation attributes associated with the first user with respect to the one or more evaluation categories may further include accessing a database storing a plurality of evaluation outputs generated based upon one or more evaluation attributes associated with a plurality of users, comparing the one or more user inputs received from the first user associated with the first user with the plurality of evaluation outputs associated with the plurality of users, and determining the one or more evaluation attributes associated with the first user based upon the comparison.

In some embodiments, determining the one or more evaluation attributes associated with the first user with respect to the one or more evaluation categories may further include training a machine learning model on a plurality of evaluation outputs generated based upon one or more evaluation attributes associated with a plurality of user and deploying the trained machine learning model on the one or more user inputs from the first user to generate the one or more evaluation attributes of the first user.

In some embodiments, the evaluation output of the first user may be generated at a first time. In such an embodiment, the method may further include receiving an evaluation output associated with a second user at a second time that is later in time than the first time modifying the evaluation output of the first user in response to the evaluation output of the second user.

In some embodiments, the evaluation output of the first user may be iteratively updated in response to iterative generation of evaluation outputs associated with a plurality of users other than the first user.

In some embodiments, the computer-implemented method may further include determining one or more developmental resources for the first user associated with the one or more evaluation categories. In such an embodiment, the one or more developmental resources may be configured to improve the performance of the first user with respect to the one or more evaluation categories. In such an embodiment, the computer-implemented method may further include providing access for the first user to the one or more developmental resources.

In some further embodiments, the computer-implemented method may further include identifying an administrative user associated with the first user and causing transmission of a user notification to the administrative user indicative of the one or more developmental resources determined for the first user.

In other further embodiments, the computer-implemented method may further include generating a predictive evaluation output for the first user indicative of a predicted performance of the first user with respect to at least one of the one or more evaluation categories following completion of the one or more developmental resources.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described certain example embodiments of the present disclosure in general terms, reference will now be made to the accompanying drawings. The components illustrated in the figures may or may not be present in certain embodiments described herein. Some embodiments may include fewer (or more) components than those shown in the figures.

FIG. 1 illustrates an example distributed computing system for implementing one or more embodiments of the present disclosure;

FIG. 2 illustrates a block diagram of example server circuitry that may be specifically configured in accordance with an example embodiment of the present disclosure;

FIG. 3 illustrates a flowchart of an example method for data indexing and evaluation in accordance with some embodiments of the present disclosure;

FIG. 4 illustrates a flowchart of an example method for user input object presentation in accordance with some embodiments of the present disclosure;

FIG. 5 illustrates a flowchart of an example method for database evaluation comparisons in accordance with some embodiments of the present disclosure;

FIG. 6 illustrates a flowchart of an example method for machine learning based determinations in accordance with some embodiments of the present disclosure;

FIG. 7 illustrates a flowchart of an example method for developmental resource provisioning in accordance with some embodiments of the present disclosure;

FIGS. 8A-8B illustrate example presentations of one or more example input objects in accordance with some embodiments of the present disclosure; and

FIG. 9 illustrates one or more example evaluation outputs in accordance with some embodiments of the present disclosure.

### DETAILED DESCRIPTION

### Overview

Various embodiments of the present disclosure will now be described more fully hereinafter with reference to the accompanying drawings in which some but not all embodiments are shown. Indeed, the present disclosure may be embodied in many different forms and should not be construed as limited to the embodiments set forth herein; rather these embodiments are provided so that this disclosure will satisfy applicable legal requirements. Like reference numerals refer to like elements throughout.

As described above, computing environments may be formed by various distributed and communicably coupled computing components, devices, and/or the like that may be further associated with various users (e.g., via user devices). These users may access applications or other functionality that is provided by these computing environments and generate user data during these interactions. By way of a non-limiting example, a distributed computing environment may be accessed by individual investors, financial professionals, institutional lenders, and/or the like to interact with various financial related applications. The data generated in response to the interactions by users (e.g., via respective user devices or otherwise) in these environments, however, has conventionally failed to be effectively indexed and subsequently evaluated to ascertain underlying user performance. Said differently, traditional systems fail to effectively extract user data in a form that is usable for evaluation (e.g., benchmarking, comparison, etc.) of the performance of the user with respect to various evaluation categories associated with the particular application or service offered by the system. Furthermore, these conventional solutions fail to iteratively identify potential developmental resources for providing to users to improve deficient evaluation attributes (e.g., relative to other users or the like).

In order to solve these issues and others, the embodiments of the present disclosure dynamically generate user input objects that are associated with various evaluation categories for interaction with a first user. Based upon the user inputs by the first user via the user input objects, the systems of the present disclosure may determine evaluation attributes of the first user and an evaluation output indicative of a performance of the first user with respect to at least the one or more evaluation categories. In some embodiments, the evaluation attribute determination may include a comparison between the user inputs of the first user and a plurality of evaluation outputs generated based upon one or more evaluation attributes associated with a plurality of users. In other embodiments, one or more trained machine learning models may be deployed on the user inputs of the first user to determine evaluation attributes of the first user. In doing so, the embodiments of the present disclosure provide data indexing and evaluation systems that, for example, leverage machine learning and artificial intelligence techniques to provide user data evaluation and subsequent developmental resource recommendations that were historically unavailable. Although described hereinafter with reference to financial applications, evaluation categories and attributes indicative of the performance of a financial advisor, and/or developmental resources configured to improve a user's performance with respect to financial related evaluation categories, the present disclosure contemplates that the systems and methods described herein may be applicable to any user data environment without limitation.

As used herein, the terms “data,” “content,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein as receiving data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein as sending data to another computing device, it will be appreciated that the data may be sent directly to another computing device or may be sent indirectly via one or more intermediary computing devices, such as, for example, one or more servers, relays, routers, network access points, base stations, hosts, and/or the like.

Embodiments of the present disclosure are described below with reference to block diagrams and flowchart illustrations. Thus, it should be understood that each block of the block diagrams and flowchart illustrations may be implemented in the form of a computer program product; an entirely hardware embodiment; an entirely firmware embodiment; a combination of hardware, computer program products, and/or firmware; and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

The terms “illustrative,” “exemplary,” and “example” as may be used herein are not provided to convey any qualitative assessment, but instead merely to convey an illustration of an example. Thus, use of any such terms should not be taken to limit the spirit and scope of embodiments of the present disclosure. The phrases “in one embodiment,” “according to one embodiment,” and/or the like generally mean that the particular feature, structure, or characteristic following the phrase may be included in at least one embodiment of the present disclosure and may be included in more than one embodiment of the present disclosure (importantly, such phrases do not necessarily refer to the same embodiment).

### Example Data Indexing and Evaluation Systems

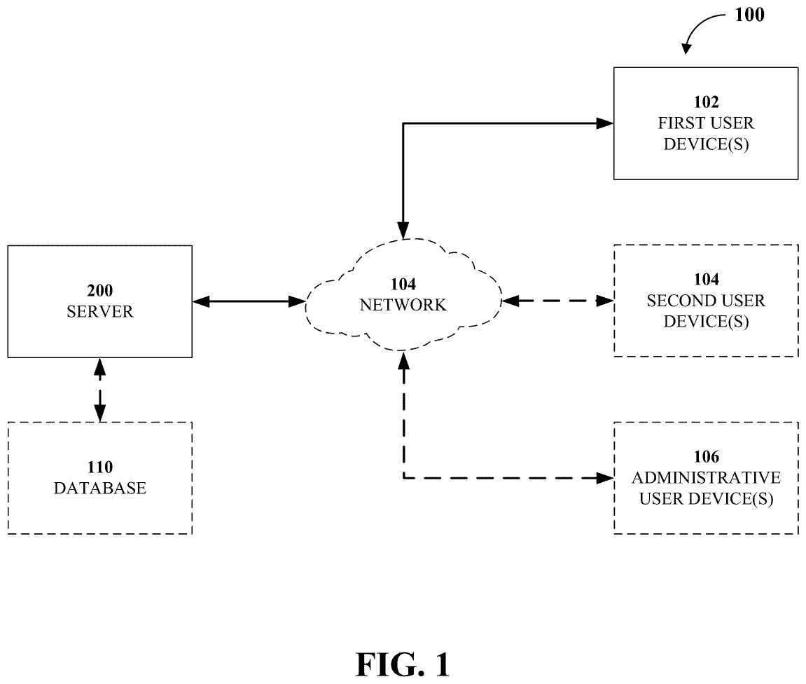

FIG. 1 illustrates a data indexing and evaluation system 100 (e.g., system 100) as an example system for indexing and evaluating user-related data as part of evaluating the performance of a user with respect to various criteria (e.g., evaluation categories). It will be appreciated that the system 100 is provided as an example of an embodiment(s) and should not be construed to narrow the scope or spirit of the disclosure. The depicted system 100 of FIG. 1 may include a server 200 (e.g., a centralized computing device) capable of generating user input objects for presentation to a user and evaluating the responses (e.g., user inputs) provided by the user to evaluate the user's performance. The server 200 may be further communicatively connected to one or more user device(s) (e.g., first user device(s) 102, second user device(s) 104, administrative user device(s) 106) by a communication network 104. Furthermore, in some embodiments, the system 100 may include or communicate with a database 110 configured to store a plurality of evaluation outputs generated based upon one or more evaluation attributes associated with a plurality of users as described herein.

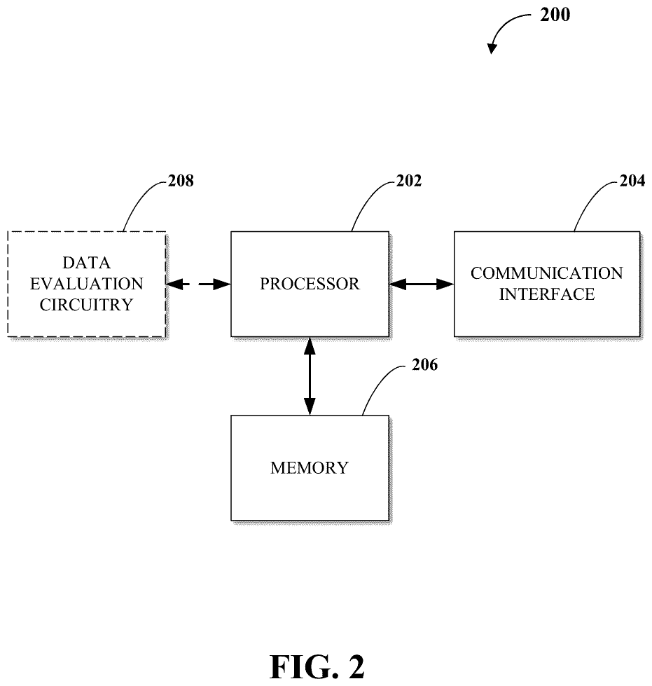

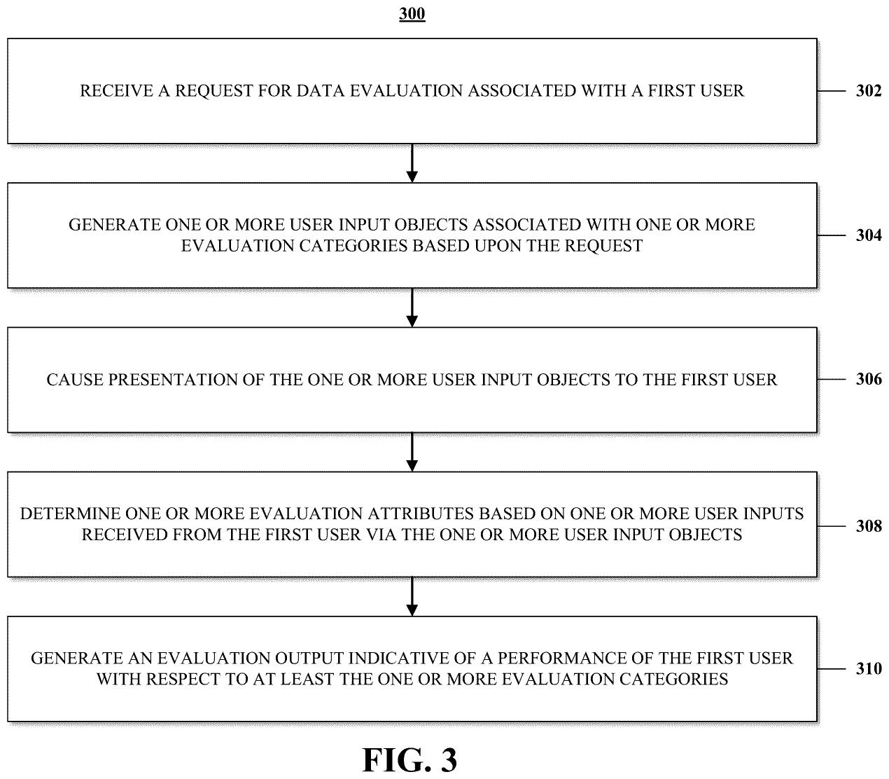

Although described hereinafter with reference to a server 200, the present disclosure contemplates that the operations described with reference to FIGS. 3-7 may be performed by any computing device, system orchestrator, central processing unit (CPU), graphics processing unit (GPU), and/or the like. Furthermore, although illustrated as a single device (e.g., server 200), the present disclosure contemplates that any number of distributed components may collectively be used to perform the operations described herein. The server 200 may be embodied in an entirely hardware embodiment, an entirely computer program product embodiment, an entirely firmware embodiment (e.g., application-specific integrated circuit, field-programmable gate array, etc.), and/or an embodiment that comprises a combination of computer program products, hardware, and firmware. Example embodiments contemplated herein may have various form factors and designs but will nevertheless include at least the components illustrated in FIG. 2 and described in connection therewith. In some embodiments, the server 200 may be located remotely from the first user device 102, the second user device 104, the administrative user device 106, and/or the database 110, although in other embodiments, the server 200 may comprise the first user device 102, the second user device 104, the administrative user device 106, and/or the database 110. The server 200 may, in some embodiments, comprise several servers or computing devices performing interconnected and/or distributed functions. Despite the many arrangements contemplated herein, the server 200 is shown and described herein as a single computing device to avoid unnecessarily overcomplicating the disclosure.

The communication network 104 may be any means including hardware, software, devices, or circuitry that is configured to support the transmission of computer messages between system nodes. For example, the communication network 104 may be formed of components supporting wired transmission protocols, such as digital subscriber line (DSL), Ethernet, fiber distributed data interface (FDDI), or any other wired transmission protocol as would be recognized by a person of ordinary skill in the art in light of this disclosure. The communication network 104 may also be comprised of components supporting wireless transmission protocols, such as Bluetooth, IEEE 802.11 (Wi-Fi), or other wireless protocols obvious to a person of ordinary skill in the art. In addition, the communication network 104 may be formed of components supporting a standard communication bus, such as, a Peripheral Component Interconnect (PCI), PCI Express (PCIe or PCI-e), PCI eXtended (PCI-X), Accelerated Graphics Port (AGP), or other similar high-speed communication connection. Further, the communication network 104 may be comprised of any combination of the above-mentioned protocols. In some embodiments, such as when the first user device 102, the second user device 104, the administrative user device 106, and/or the database 110 and the server 200 are formed as part of the same physical device, the communication network 104 may include the on-board wiring providing the physical connection between the component devices.

The system 100 may include one or more user devices that are associated with various users as described above. For example, the system may include a first user device 102 associated with a first user that refers to computer hardware that is configured (either physically or by the execution of software) to access one or more services made available by the server 200 and, among various other functions, is configured to directly, or indirectly, transmit and receive data. Example first user devices 102 may include a smartphone, a tablet computer, a laptop computer, a wearable device (e.g., smart glasses, smart watch, or the like), and the like. In some embodiments, the first user device 102 may include a “smart device” that is equipped with a chip or other electronic device that is configured to communicate with the external device via Bluetooth, NFC, Wi-Fi, 3G, 4G, 5G, RFID protocols, and the like. By way of a particular example, the first user device 102 may be a mobile phone equipped with a Wi-Fi radio that is configured to communicate with a Wi-Fi access point that is in communication with the server 200 or other computing device via a network. Although illustrated as a single first user device 102 in FIG. 1, the present disclosure contemplates that any number of user devices may be associated with the first user without limitation.

In some embodiments, such as instances in which a plurality of users (e.g., a first user, a second user, . . . , an N^{th} user) are interacting with the server 200, the system 100 may include at least a second user device 104 associated with a second user that refers to computer hardware that is configured (either physically or by the execution of software) to access one or more services made available by the server 200 and, among various other functions, is configured to directly, or indirectly, transmit and receive data. Example second user devices 104 may include a smartphone, a tablet computer, a laptop computer, a wearable device (e.g., smart glasses, smart watch, or the like), and the like. In some embodiments, the second user device 104 may include a “smart device” that is equipped with chip of other electronic device that is configured to communicate with the external device via Bluetooth, NFC, Wi-Fi, 3G, 4G, 5G, RFID protocols, and the like. By way of a particular example, the second user device 104 may be a mobile phone equipped with a Wi-Fi radio that is configured to communicate with a Wi-Fi access point that is in communication with the server 200 or other computing device via a network. Although illustrated as a single second user device 102 in FIG. 1, the present disclosure contemplates that any number of user devices and associated users may interact with the server 200 based upon the intended application of the system 100.

In some embodiments as described hereafter, the system 100 may include an administrative user device 106 that is associated with an administrative user. The administrative user may, for example, refer to a user to which the first user reports, receives instructions, and/or the like. Said differently, the administrative user(s) described herein may refer to any user with authority over the first user and/or that is responsible for the evaluation and improvement of the first user. To this end, the administrative user device 106 may similarly include a smartphone, a tablet computer, a laptop computer, a wearable device (e.g., smart glasses, smart watch, or the like), and the like. The administrative user device 106 may include a “smart device” that is equipped with chip of other electronic device that is configured to communicate with the external device via Bluetooth, NFC, Wi-Fi, 3G, 4G, 5G, RFID protocols, and the like. By way of continued example, the administrative user device 106 may be a mobile phone equipped with a Wi-Fi radio that is configured to communicate with a Wi-Fi access point that is in communication with the server 200 or other computing device via a network. In some instances, the administrative user device 106 may be configured to generate and provide transmissions to the first user device 102, such as to assign particular developmental resources to the first user.

With continued reference to FIG. 1, the system 100 may include a database 110 that may be any suitable storage device configured to store some or all of the information described herein (e.g., a memory 206 of the server 200 or a separate memory system separate from the server 200, such as one or more database systems, backend data servers, network databases, cloud storage devices, or the like). The database 110 may include data received from the server 200 (e.g., via a memory 206 and/or processor(s) 202) or the user device(s) described above, and the corresponding storage device may thus store this data.

### Example Server Circuitry

With reference to FIG. 2, example circuitry components of the server 200 are illustrated that may, alone or in combination with any of the components described herein, be configured to perform the operations described herein with reference to FIGS. 3-7. As shown, the server 200 may include, be associated with or be in communication with a processor 202, a memory 206, and a communication interface 204. In some embodiments, the server 200 may include data evaluation circuitry 208. The processor 202 may be in communication with the memory 206 via a bus for passing information among components of the server 200. The memory 206 may be non-transitory and may include, for example, one or more volatile and/or non-volatile memories. In other words, for example, the memory 206 may be an electronic storage device (e.g., a computer readable storage medium) comprising gates configured to store data (e.g., bits) that may be retrievable by a machine (e.g., a computing device like the processing circuitry). The memory 206 may be configured to store information, data, content, applications, instructions, or the like for enabling the apparatus to carry out various functions in accordance with an example embodiment of the present disclosure. For example, the memory 206 could be configured to buffer input data for processing by the processor 202. Additionally or alternatively, the memory 206 could be configured to store instructions for execution by the processor 202.

The server 200 (e.g., example apparatus of the present disclosure) may, in some embodiments, be embodied in various computing devices as described above. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present disclosure on a single chip or as a single “system on a chip.” As such, in some cases, a chip or chipset may constitute means for performing one or more operations for providing the functionalities described herein.

The processor 202 may be embodied in a number of different ways. For example, the processor 202 may be embodied as one or more of various hardware processing means such as a coprocessor, a microprocessor, a controller, a digital signal processor (DSP), a processing element with or without an accompanying DSP, or various other circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry may include one or more processing cores configured to perform independently. A multi-core processing circuitry may enable multiprocessing within a single physical package. Additionally or alternatively, the processing circuitry may include one or more processors configured in tandem via the bus to enable independent execution of instructions, pipelining and/or multithreading.

In an example embodiment, the processor 202 may be configured to execute instructions stored in the memory 206 or otherwise accessible to the processor 202. Alternatively or additionally, the processing circuitry may be configured to execute hard coded functionality. As such, whether configured by hardware or software methods, or by a combination thereof, the processing circuitry may represent an entity (e.g., physically embodied in circuitry) capable of performing operations according to an embodiment of the present disclosure while configured accordingly. Thus, for example, when the processing circuitry is embodied as an ASIC, FPGA or the like, the processing circuitry may be specifically configured hardware for conducting the operations described herein. Alternatively, as another example, when the processor 202 is embodied as an executor of instructions, the instructions may specifically configure the processor to perform the algorithms and/or operations described herein when the instructions are executed. However, in some cases, the processor 202 may be a processor of a specific device configured to employ an embodiment of the present disclosure by further configuration of the processing circuitry by instructions for performing the algorithms and/or operations described herein. The processor 202 may include, among other things, a clock, an arithmetic logic unit (ALU) and logic gates configured to support operation of the processing circuitry.

The communication interface 204 may be any means such as a device or circuitry embodied in either hardware or a combination of hardware and software that is configured to receive and/or transmit data, including media content in the form of video or image files, one or more audio tracks or the like. In this regard, the communication interface 204 may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

In some embodiments, the server 200 may include the data evaluation circuitry 208 that may include hardware components configured to compare one or more user inputs (e.g., of a first user) with a plurality of evaluation outputs associated with other users to generate evaluation attributes of the first user. In some embodiments, the server 200 may leverage machine learning and/or artificial intelligence to generate evaluation attributes of the first user. As such, in such an embodiment, the data evaluation circuitry 208 may include any device, module, component, circuitry, etc. configured to train a machine learning model on a plurality of evaluation attributes and outputs and deploy the trained machine learning model on the one or more user inputs from the first user to generate the one or more evaluation attributes of the first user. The data evaluation circuitry 208 may utilize processing circuitry, such as the processor 202, to perform its corresponding operations, and may utilize memory 206 to store collected information.

Of course, while the term “circuitry” should be understood broadly to include hardware, in some embodiments, the term “circuitry” may also include software for configuring the hardware. For example, although “circuitry” may include processing circuitry, storage media, network interfaces, input/output devices, and the like, other elements of the server 200 may provide or supplement the functionality of particular circuitry.

### Example Methods for Data Indexing and Evaluation

FIG. 3 illustrates a flowchart containing a series of operations for data indexing and evaluation (e.g., method 300). The operations illustrated in FIG. 3 may, for example, be performed by, with the assistance of, and/or under the control of an apparatus (e.g., server 200), as described above. In this regard, performance of the operations may invoke one or more of the processor 202, memory 206, communication interface 204, and/or data evaluation circuitry 208.

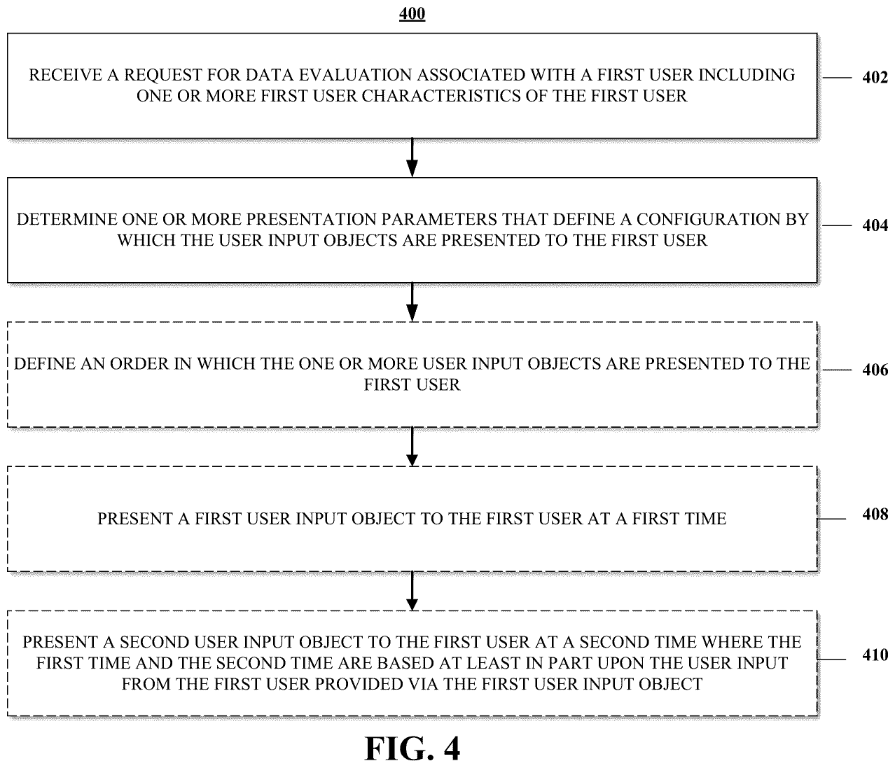

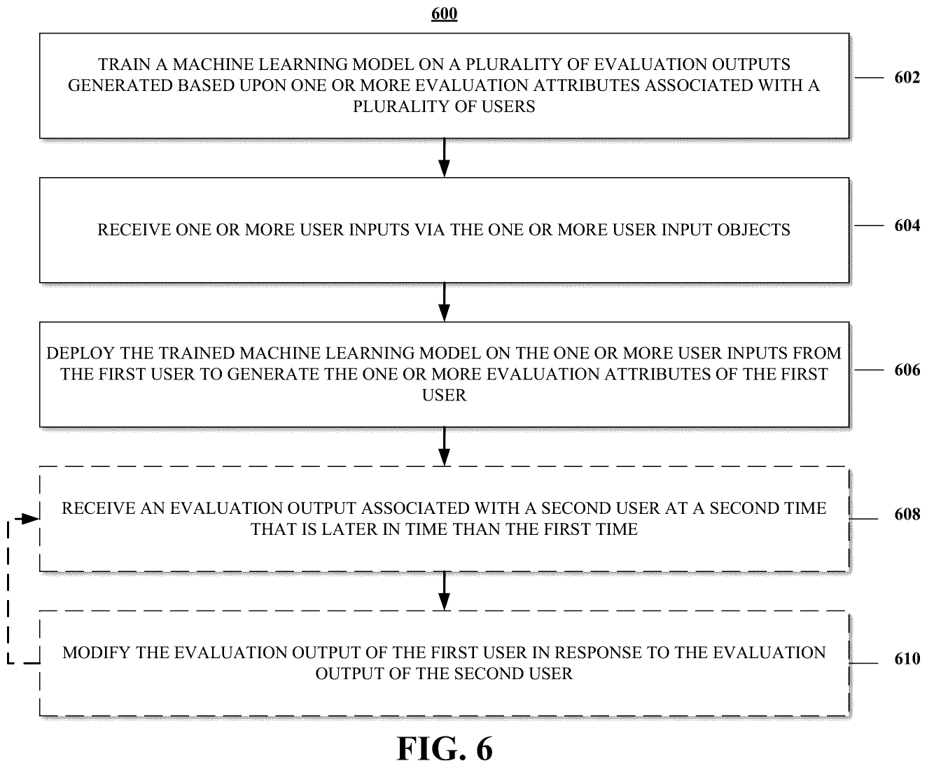

As shown in operation 302, the apparatus (e.g., server 200) may include means, such as communication interface 204, or the like, for receiving a request for data evaluation associated with a first user. As described above, in some embodiments, the system 100 may be associated with or otherwise accessed by a plurality of users associated with financial applications, such as individual investors, financial professionals, and/or institutional lenders. By way of a particular, non-limiting example, the first user may be a financial advisor such that the request received at operation 302 refers to a request by the first user to participate in an evaluation of the first user (e.g., a financial advisor) with respect to financial related evaluation categories. In such an embodiment, the first user may, via the first user device 102, transmit the request to the server 200. In instances in which the data indexing and evaluation operations described herein are iteratively performed (e.g., as described hereafter with reference to FIG. 6), the request at operation 302 may refer to a request by the first user device 102, the server 200, and/or any device communicably coupled thereto to iteratively perform the operations of FIG. 4.

In some embodiments, the first user may report to and/or receive instructions from an administrative user (e.g., user with authority over the first user and/or responsible for the evaluation and improvement of the first user). In such an embodiment, the request received at operation 302 may be received from an administrative user device 106 of the administrative user associated with the first user. By way of a particular, non-limiting example, the administrative user may be a manager of a team, group, or the like that includes the first user, and the administrative user may assign the first user to participate in an evaluation with respect to financial related evaluation categories. The administrative user, for example, may input a request for the first user to participate in a data evaluation via the administrative user device 106 (e.g., an administrative dashboard) that is received by the server 200 at operation 302.

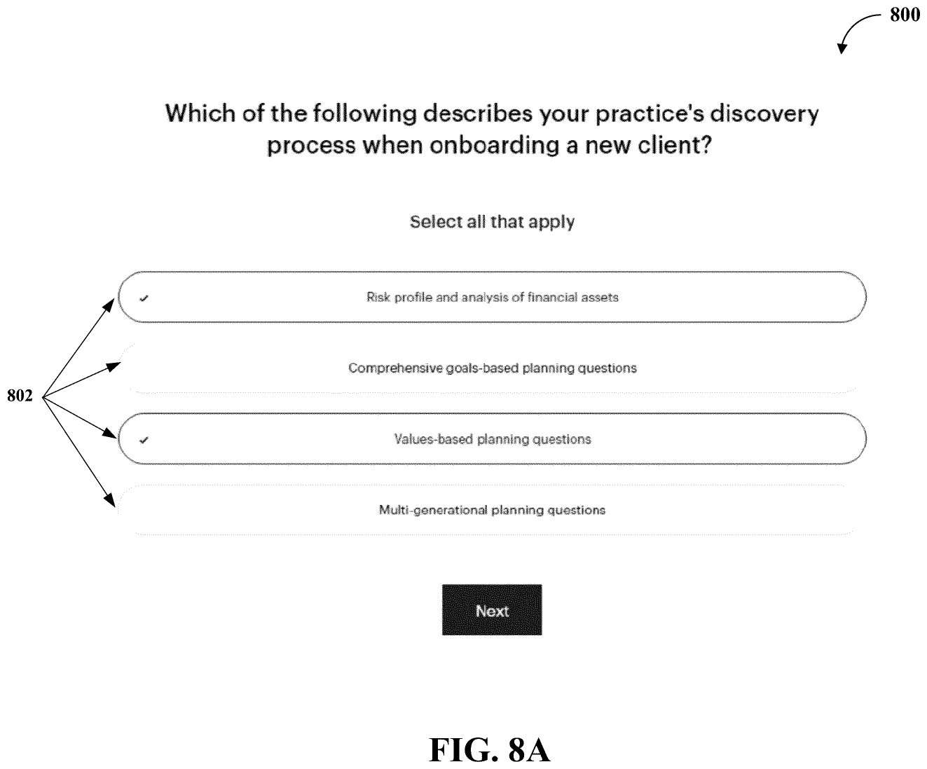

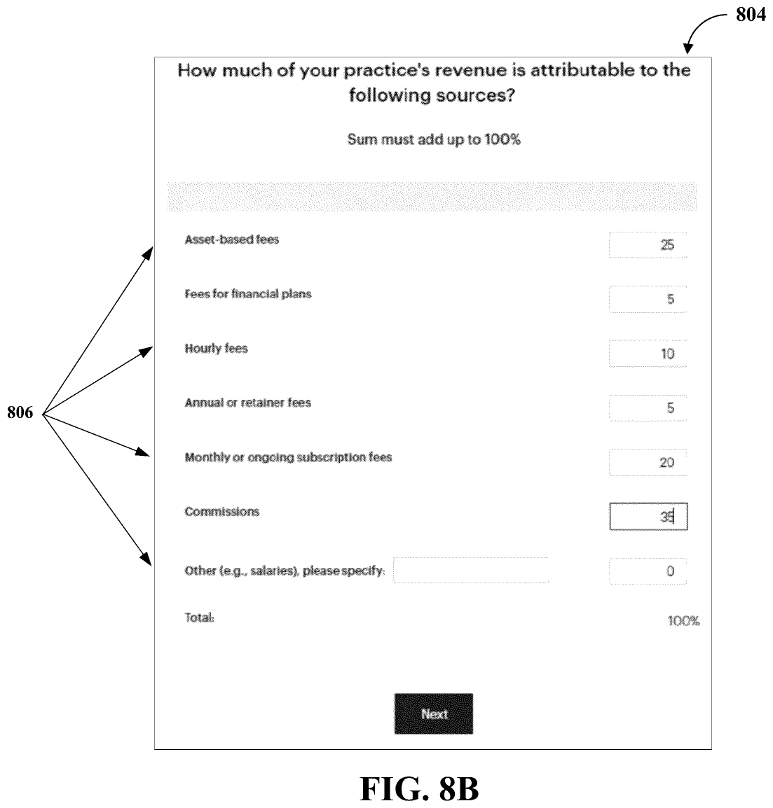

Thereafter, as shown in operation 304, the apparatus (e.g., server 200) may include means, such as the processor 202, or the like, for generating one or more user input objects based upon the request. As described more fully hereafter with reference to FIG. 4 and illustrated in FIGS. 8A-8B, the one or more user input objects may refer to any interactive element through which the user may provide user inputs to the server 200. By way of example, the one or more user input objects may, in some embodiments, cause presentation of one or more questions to which the first user may provide a response (e.g., a user input). The one or more user input objects may further be associated with one or more evaluation categories. The evaluation categories may, for example, refer to groupings, classifications, and/or the like by which user input objects may be grouped based upon commonalities or other associations. By way of continued example, the data evaluation may be associated with performance of the first user (e.g., a financial advisor) with respect to financial related evaluation categories (e.g., new business development, wealth management, client service, and/or practice management). In other words, the user input objects generated at operation 304 may, for example, cause the presentation of one or more questions to the first user, the answers to which are at least partially indicative of the first user's performance with respect to new business development, wealth management, client service, and/or practice management.

Thereafter, as shown in operation 306, the apparatus (e.g., server 200) may include means, such as the processor 202, or the like, for causing presentation of the one or more user input objects to the first user. The user input objects generated at operation 304 may be, for example, presented to the first user via one or more user interfaces with which the first user may interact. In such an example embodiment, the server 200 may transmit the one or more user input objects to the first user device 102 with instructions to render the user input objects to the first user. In other embodiments, the server 200 may be configured to provide the one or more user input objects to the first user (e.g., via a display of the server 200 or the like). In such an embodiment, the performance of operation 306 may refer to a rendering of a user interface by the server 200 that provides the one or more user input objects to the first user, such as illustrated in the example presentations 800, 804 in FIGS. 8A-8B.

Thereafter as shown in operation 308, the apparatus (e.g., server 200) may include means, such as the processor 202, or the like, for receiving one or more user inputs from the first user via the one or more user input objects and determining one or more evaluation attributes associated with the first user based on the received one or more user inputs. In an embodiment in which the one or more user input objects are provided by the server 200 to the first user device 102, the server 200 may receive one or more user inputs from the first user device 102 (e.g., via a transmission between the first user device 102 and the server 200) that are provided via the one or more user input objects presented to the first user via the first user device 102. In an instance in which the one or more user input objects are provided directly to the first user via the server 200, the receipt of the one or more user inputs from the first user via the one or more user input objects may occur internally to the server 200. In some embodiments, the one or more user inputs from the first user via the one or more user input objects may be reviewed by one or more other users prior to further evaluation by the server 200. For example, the user inputs provided via the one or more user inputs objects may be transmitted from the first user device 102 to the administrative user device 106 for review prior to providing these inputs to the server 200. In this way, the administrative user may, in some embodiments, review the accuracy of the user inputs provided by the first user.

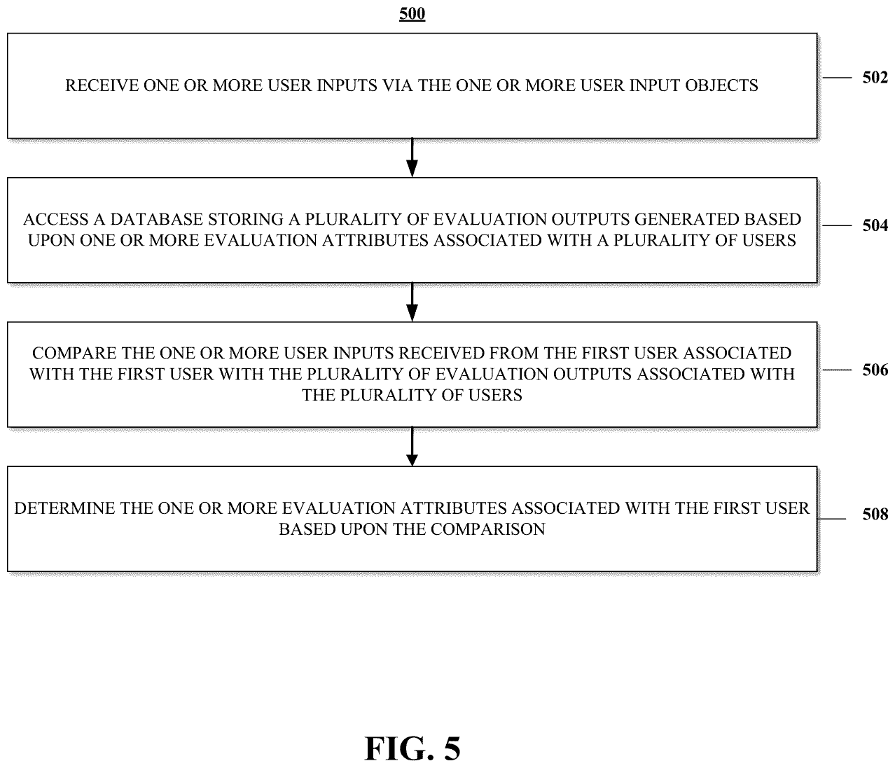

With continued reference to operation 308, the server 200 may determine one or more evaluation attributes of the first user associated with the various evaluation categories defined by the one or more user input objects. The one or more evaluation attributes may, by way of continued example, be associated with an evaluation of data indicative of or related to the performance of the first user (e.g., a financial advisor) with respect to financial related evaluation categories (e.g., new business development, wealth management, client service, and/or practice management). In other words, an evaluation attribute for the first user may be a benchmark, gauge, score, or other measure of the first user's performance relative other users, industry averages, entity expectations, a combination of these factors, and/or the like. The evaluation attributes of the present disclosure, described more fully herein with reference to FIGS. 5-6, may refer to any parameter, characteristic, criterion, aspect, etc. that may be used by the server 200 to provide an output (e.g., evaluation output) for review by the first user, administrative user, etc. that represents the first user's performance. By way of a particular example, an evaluation attribute of the first user for a particular evaluation category (e.g., wealth management) may indicate the performance (e.g., investment returns) of the first user relative to other users (e.g., at least a second user), relative to other entities, and/or relative to the investment industry as a whole or to a relevant portion thereof. As would be evident to one of ordinary skill in the art in light of the present disclosure, the evaluation attribute for the first user for a particular evaluation category may be generated in response to a plurality of user inputs (e.g., received via user input objects) that are associated with this evaluation category (e.g., the first user's response to a plurality of questions associated with the example wealth management evaluation category).

As described hereafter with reference to FIG. 5, in some embodiments, the server 200 may generate the one or more evaluation attributes for the first user in response to a comparison between a plurality of evaluation outputs generated based upon one or more evaluation attributes associated with a plurality of users (e.g., users other than the first user) and the user inputs of the first user. By way of example, the one or more user inputs of the first user associated with a particular evaluation category may be compared with evaluation attributes (e.g., generated based upon the user inputs of other users) associated with the same evaluation category. This comparison may provide the performance of the first user relative the plurality of other users with respect to this particular evaluation category. The evaluation attribute of the first user in such an embodiment may be represented as a ranking of the first user or the like (e.g., greater than 50% of other users, in the top 25% of all users, etc.). The form and/or format of the evaluation attribute may vary based upon the intended application of the system 100. In some embodiments, the form and/or format of the evaluation may be customizable, such as by the first user or by the administrative user.

In other embodiments, as described hereafter with reference to FIG. 6, the server 200 may leverage one or more machine learning models and/or artificial intelligence techniques to generate the one or more evaluation attributes of the first user. By way of example, a machine learning model may be supplied with a plurality of evaluation attributes and associated evaluation outputs (e.g., generated in response to various prior performances of the operations of FIG. 3) to train the machine learning model. The machine learning (ML) model may be subsequently deployed on the one or more user inputs of the first user in order to generate the one or more evaluation attributes of the first user. As described hereafter, the trained ML model may also to a mathematical model generated by machine learning algorithms based on training data (e.g., various feature sets of evaluation attributes), to make predictions or decisions without being explicitly programmed to do so and may be configured to selectively weight particular user inputs based upon the intended application of the system 100. For example, a particular user input may be more indicative of performance with respect to a particular evaluation category as compared to another user input and may be weighted by the server 200 accordingly.

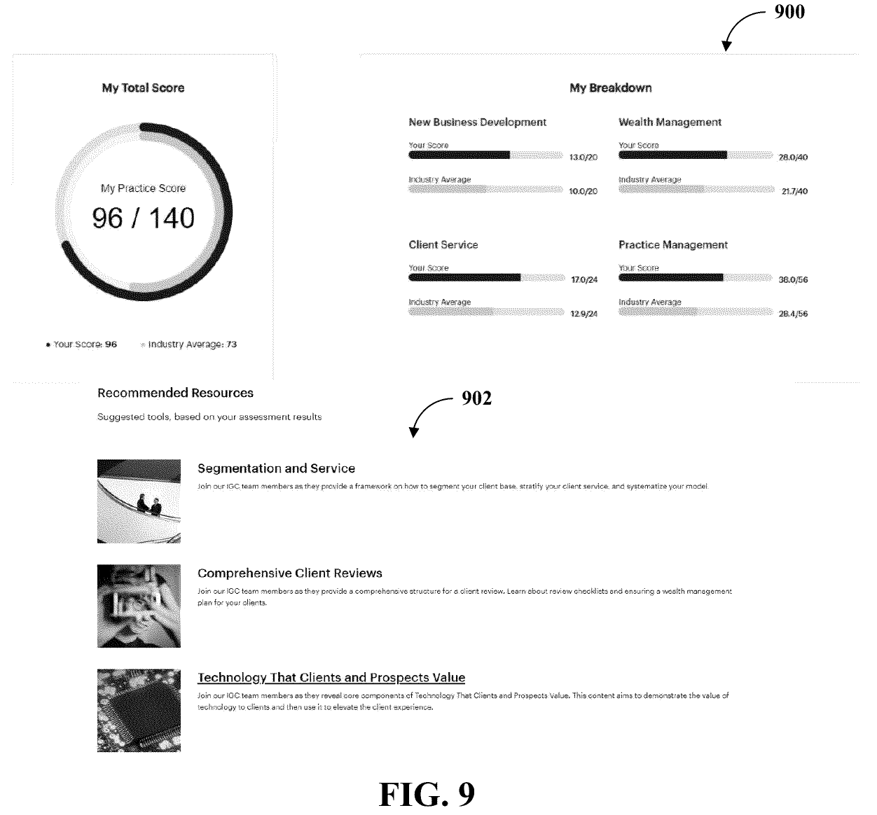

Thereafter as shown in operation 310, the apparatus (e.g., server 200) may include means, such as processor 202, or the like, for generating an evaluation output indicative of a performance of the first user with respect to at least the one or more evaluation categories. As described and illustrated herein, the evaluation output may refer to the mechanism by which the server 200 presents the results of the data indexing and evaluation operations of FIG. 3. For example, the evaluation output may refer to a summary of the first user's performance, as defined by the evaluation attributes, with respect to the one or more evaluation categories. In some embodiments, the evaluation output may refer to a user interface that is provided to the first user, via the first user device 102 or otherwise, that illustrates or displays the evaluation attributes of the first user. The present disclosure contemplates that the arrangement, orientation, configuration, etc. of such a user interface providing the generated evaluation output may vary based upon the intended application of the system 100, the capabilities or functionality of the first user device 102, and/or the like. In some embodiments, the evaluation output may refer to a user interface that is supplied to an administrative user, via the administrative user device 106, that illustrates or displays the evaluation attributes of the first user for review by the administrative user as described above. An example evaluation output (e.g., via user interface or the like) of example evaluation attributes is illustrated in FIG. 9. Although described herein with reference to evaluation attributes of a first user, the present disclosure contemplates that the operations of FIG. 3 may be performed for any number of other users (e.g., at least a second user) accessing the application(s) provided by the server 200.

FIG. 4 illustrates a flowchart containing a series of operations for user input object presentation (e.g., method 400). The operations illustrated in FIG. 4 may, for example, be performed by, with the assistance of, and/or under the control of an apparatus (e.g., server 200), as described above. In this regard, performance of the operations may invoke one or more of the processor 202, memory 206, communication interface 204, and/or data evaluation circuitry 208.

As shown in operation 402, the apparatus (e.g., server 200) may include means, such as the processor 202, communication interface 204, or the like, for receiving a request for data evaluation associated with a first user that includes one or more first user characteristics of the first user. As described above with reference to operation 302 in FIG. 3, the server 200 may receive the request for data evaluation from the first user device 102, the administrative user device 106, and/or any device communicably coupled with the server 200. In some embodiments, the request for data evaluation may further include various characteristics of the first user that at least partially define the identity of the first user. By way of example, the name, associated entity, location, communication channel, user device type or capability, etc. associated with the first user may be received by the server 200. In such an embodiment, the one or more user characteristics may at least partially impact or influence the presentation of the user input objects to the first user as described hereafter. The present disclosure contemplates that the server 200 may receive any user characteristics, attribute, data entry, etc. associated with the first user based upon the intended application of the system 100 without limitation.

Thereafter, as shown in operation 404, the apparatus (e.g., server 200) may include means, such as the processor 202 or the like, for determining one or more presentation parameters that define a configuration by which the user input objects are presented to the first user. In some embodiments, the server 200 may operate to present the user input objects to the first user in an arrangement that is personalized to the first user (e.g., a personalized interface and/or interactive experience). In such an embodiment, the server 200 may determine various presentation parameters that define a configuration by which the user input objects are presented to the first user that may refer to the positioning of user input objects on the display, the orientation of user input objects, the relative positioning between user input objects, the selection of certain user input objects for presentation and/or the exclusion of other, the sequence or chronology for presentation of the user input objects, and/or the like within a user interface. By way of an additional example, the presentation parameters may define the style, color, animation, transitions, etc. used by the user interface to display the one or more user input objects.

In some embodiments, for example, the presentation parameters may be determined based upon an entity associated with the first user (e.g., as defined by the one or more first user characteristics) such that the user input objects presented to users of a particular entity have the same configuration. In other embodiments, the presentation parameters may be determined based upon one or more user preferences provided by the first user indicative of a preferred configuration of the first user. In any embodiments, the one or more evaluation categories may be selected at least partially based upon the one or more first user characteristics. For example, a particular entity associated with the first user (e.g., as defined by the one or more first user characteristics) may determine a particular set of evaluation categories relevant to the first entity, and the operations of FIG. 3 may be performed with the evaluation categories defined by the entity. In some embodiments, each of the user input objects may be presented to the first user simultaneously (e.g., a plurality of questions are presented to the first user) or the generated user input objects may be provided to the first user in a defined order that is the same for all users (e.g., a plurality of the same questions in the same order are presented to each user interacting with the server 200).

The one or more presentation parameters for the user input objects may further operate to define the way in which the first user may interact with the user input objects. In some embodiments, for example, the user input objects may include questions that allow for the first user to provide a free text or open response to the question defined by the user input object. In some instances, the user input objects may provide a plurality of pre-defined response options (e.g., a drop down selectable list, an interactable slider, etc.) that are presented to the user for selection. In some embodiments, the user input objects may provide a recommended response for selection by the first user, such as a recommendation based upon the analysis of the first user characteristics associated with the first user or based on previous responses received from the first user or other user inputs. The present disclosure contemplates that the user input objects may include any mechanism for receiving a user input based upon the intended application of the system 100.

In other embodiments, as shown in operation 406, the apparatus (e.g., server 200) may include means, such as the processor 202 or the like, for defining an order in which the one or more user input objects are presented to the first user. In such an embodiment, the defined order (e.g., a presentation order) of the user input objects may be user-specific in that the order in which the user input objects are presented to the first user is specific to the first user. By way of example, a plurality of user input objects (e.g., questions or the like) may be presented to the first user in an order that is different from an order in which the plurality of user input objects (e.g., questions or the like) are presented to a second user. Furthermore, the present disclosure contemplates that the user input objects presented to the user may be associated with the same or different evaluation categories. By way of a particular example, in some embodiments, a first user input object presented to the first user may be associated with a first evaluation category (e.g., wealth management), and a second user input object presented to the first user may be associated with a second evaluation category (e.g., client service). In other embodiments, the first user input object and the second user input object may be associated with the same evaluation category.

In some embodiments, as shown in operation 408, the apparatus (e.g., server 200) may include means, such as the processor 202 or the like, for presenting a first user input object to the first user at a first time. The first user input object may be displayed to the first user via the first user device and be associated with one or more evaluation categories. The input by the first user to the first user input object (e.g., the first user's response) may, for example, impact the selection of the second user input object (e.g., a subsequent question) that is presented to the first user. As shown in operation 410, for example, the apparatus (e.g., server 200) may include means, such as the processor 202 or the like, for presenting a second user input object to the first user at a second time where the first time and the second time are based at least in part upon the user input from the first user provided via the first user input object. For example, a second time that is later in time than the first time may be determined for presentation of the second user input object to the first user in that the response by the first user to the first user input object may be required for interaction with the second user input object (e.g., a question dependency or the like). In this way, the embodiments of the present disclosure may provide an interactive user experience (e.g., user interface or the like) that is dynamic in nature and responsive to the particular user interacting with the user input objects.

FIG. 5 illustrates a flowchart containing a series of operations for database evaluation comparisons (e.g., method 500). The operations illustrated in FIG. 5 may, for example, be performed by, with the assistance of, and/or under the control of an apparatus (e.g., server 200), as described above. In this regard, performance of the operations may invoke one or more of the processor 202, memory 206, communication interface 204, and/or data evaluation circuitry 208.

As shown in operation 502, the apparatus (e.g., server 200) may include means, such as the processor 202, communication interface 204, or the like, for receiving one or more user inputs from the first user via the one or more user input objects. As described above with reference to operation 308, the one or more user input objects are provided by the server 200 to the first user device 102, the server 200 may receive one or more user inputs from the first user device 102 (e.g., via a transmission between the first user device 102 and the server 200) that are provided via the one or more user input objects presented to the first user via the first user device. In an instance in which the one or more user input objects are provided directly to the first user via the server 200, the receipt of the one or more user inputs from the first user via the one or more user input objects may occur internally to the server 200.

Thereafter, as shown in operation 504, the apparatus (e.g., server 200) may include means, such as the processor 202, or the like, for accessing a database 110 storing a plurality of evaluation outputs generated based upon one or more evaluation attributes associated with a plurality of users. As described above, the server 200 may be comprise or be communicably coupled with a database 110 that may be any suitable storage device configured to store some or all of the information described herein. In the embodiment of FIG. 5, the database 110 may be configured to store a plurality of evaluation outputted generated based upon one or more evaluation attributes of users other than the first user. As described above, the operations described herein (e.g., the operations of FIG. 3 or otherwise) may be performed for a plurality of users in order to determine the relative performance of these users and others (e.g., the first user). As such, the various prior performances of the operations described herein may be stored by the database 110 or be otherwise accessible by the server 200.

Thereafter, as shown in operations 506 and 508, the apparatus (e.g., server 200) may include means, such as the processor 202, or the like, comparing the one or more user inputs received from the first user associated with the first user with the plurality of evaluation outputs associated with the plurality of users and determining the one or more evaluation attributes associated with the first user based upon the comparison, respectively. As described above, the one or more user inputs of the first user associated with a particular evaluation category may be compared with evaluation attributes (e.g., generated based upon the user inputs of other users) associated with the same evaluation category. This comparison may provide the performance of the first user relative the plurality of other users with respect to this particular evaluation category. The evaluation attribute of the first user in such an embodiment may be represented as a ranking of the first user or the like (e.g., greater than 50% of other users, in the top 25% of all users, etc.). In some embodiments, the comparison may occur on the user input object level in that each user's input to a particular user input object (e.g., a first user input object) may be compared, and the evaluation attribute for the first user may indicate the performance of the first user relative to other users with regard to the first user input object alone.

In other embodiments, the evaluation attribute for the first user may be based upon a comparison between a plurality of user inputs to a plurality of user input objects that are associated with the particular evaluation attribute. In other words, the collective answers (e.g., user inputs) by the first user to a plurality of questions (e.g., user input objects) may be compared against the collective answers (e.g., user inputs) by a plurality of other users in order to determine the one or more evaluation attributes. In some embodiments, particular user input objects, user inputs, evaluations categories, or the like may be weighted differently in that these elements impact the determination of the valuation attributes differently. By way of a non-limiting example, a comparison between the first user's input to a first user input object and the input by other users to the first user input object may be weighted greater than a comparison between the first user's input to a second user input object and the input by other users to the second user input object (e.g., in a case where the first user input object is considered more relevant to the performance of the first user than the second user input object). As described above, the form and/or format of the evaluation attribute may vary based upon the intended application of the system 100, and the comparisons described in the embodiment of FIG. 5 may account for any first user characteristic as described with reference to FIG. 4.

FIG. 6 illustrates a flowchart containing a series of operations for machine learning based determinations (e.g., method 600). The operations illustrated in FIG. 6 may, for example, be performed by, with the assistance of, and/or under the control of an apparatus (e.g., server 200), as described above. In this regard, performance of the operations may invoke one or more of the processor 202, memory 206, communication interface 204, and/or data evaluation circuitry 208.

As shown in operation 602, the apparatus (e.g., server 200) may include means, such as the processor 202, data evaluation circuitry 208, or the like, for training a machine learning model on a plurality of evaluation outputs generated based upon one or more evaluation attributes associated with a plurality of users. Additionally, the operations described herein (e.g., the operations of FIG. 3 or otherwise) may be performed for a plurality of users in order to determine the relative performance of these users and others (e.g., the first user). As such, the various prior performances of the operations described herein may be stored by the database 110 or otherwise accessible by the server 200. These prior performances (e.g., evaluation attributes and evaluation outputs) may be supplied to one or more example machine learning (ML) models to train these ML models to determine or generate evaluation attributes and evaluation outputs based upon new user inputs.

In this way, the trained ML model may refer to a mathematical model generated by machine learning algorithms based on training data (e.g., various feature sets of evaluation attributes), to make predictions or decisions without being explicitly programmed to do so. The trained ML model may similarly represent what was learned by the selected machine learning algorithm and represent the rules, numbers, and any other algorithm-specific data structures required for decision-making. Selecting the right machine learning algorithm may depend on a number of different factors, such as the problem statement and the kind of output needed, type and size of the data, the available computational time, number of features and observations in the data, and/or the like. The trained ML model or algorithm may also refer to programs that are configured to self-adjust and perform better as they are exposed to more data. To this extent, the trained ML model or algorithm may also be capable of adjusting its own parameters, based on previous performance in making prediction about a dataset.

Furthermore, the ML models may be trained using repeated execution cycles of experimentation, testing, and tuning to modify the performance of the ML algorithm and refine the results in preparation for deployment of those results for consumption or decision making. The ML models may be tuned by dynamically varying hyperparameters in each iteration (e.g., number of trees in a tree-based algorithm or the value of alpha in a linear algorithm), running the algorithm on the data again, and then comparing its performance on a validation set to determine which set of hyperparameters results in the most accurate model. The accuracy of the model is the measurement used to determine which set of hyperparameters is best at identifying relationships and patterns between variables in a dataset based on the input, or training data. A fully trained ML model is one whose hyperparameters are tuned and model accuracy maximized.

Thereafter, as shown in operation 604, the apparatus (e.g., server 200) may include means, such as the processor 202, communication interface 204, or the like, for receiving one or more user inputs from the first user via the one or more user input objects. As described above with reference to operation 308 and 502, the one or more user input objects are provided by the server 200 to the first user device 102, the server 200 may receive one or more user inputs from the first user device 102 (e.g., via a transmission between the first user device 102 and the server 200) that are provided via the one or more user input objects presented to the first user via the first user device. In an instance in which the one or more user input objects are provided directly to the first user via the server 200, the receipt of the one or more user inputs from the first user via the one or more user input objects may occur internally to the server 200.

Thereafter, as shown in operation 606, the apparatus (e.g., server 200) may include means, such as the processor 202, communication interface 204, or the like, for deploying the trained machine learning model on the one or more user inputs from the first user to generate the one or more evaluation attributes of the first user. The trained machine learning model may be supplied with the user inputs by the first user to the user input objects, and the trained machine learning model may output generated evaluation attributed of the first user. The ML algorithms contemplated, described, and/or used herein (e.g., the trained ML model) may include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, clastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

In some embodiments, as shown in operation 608, the apparatus (e.g., server 200) may include means, such as the processor 202, communication interface 204, or the like, for receiving an evaluation output associated with a second user at a second time that is later in time than a first time at which the evaluation output of the first user is generated. Thereafter, as shown in operation 610, the apparatus (e.g., server 200) may include means, such as the processor 202, or the like, for modifying the evaluation output of the first user in response to the evaluation output of the second user. Operations 608, 610 illustrate an example embodiment of the present disclosure in which the evaluation outputs that are provided to users may be dynamically (e.g., in real or substantially real time) updated to account for the evaluation attributes and outputs of other users. For example, as the number of users for which an evaluation output has been determined, such as via the operations of FIG. 3, grows, the relative performance of the subject user (e.g., the first user) may change (e.g., increase or decrease). In order to avoid the evaluation attributes stagnating or otherwise failing to accurately reflect updates in the relative performance of other users, the server 200 may operate to dynamically update or modify previously determined evaluation outputs, such as by modifying the evaluation output for the first user in response to receiving an evaluation output associated with another user (e.g., the second user). Said differently, the evaluation output of the first user may be iteratively updated in response to iterative generation of evaluation outputs associated with a plurality of users other than the first user. Although illustrated and described herein with reference to FIG. 6, the iterative nature of operations 608, 610 may be applied to any of the methods described herein.

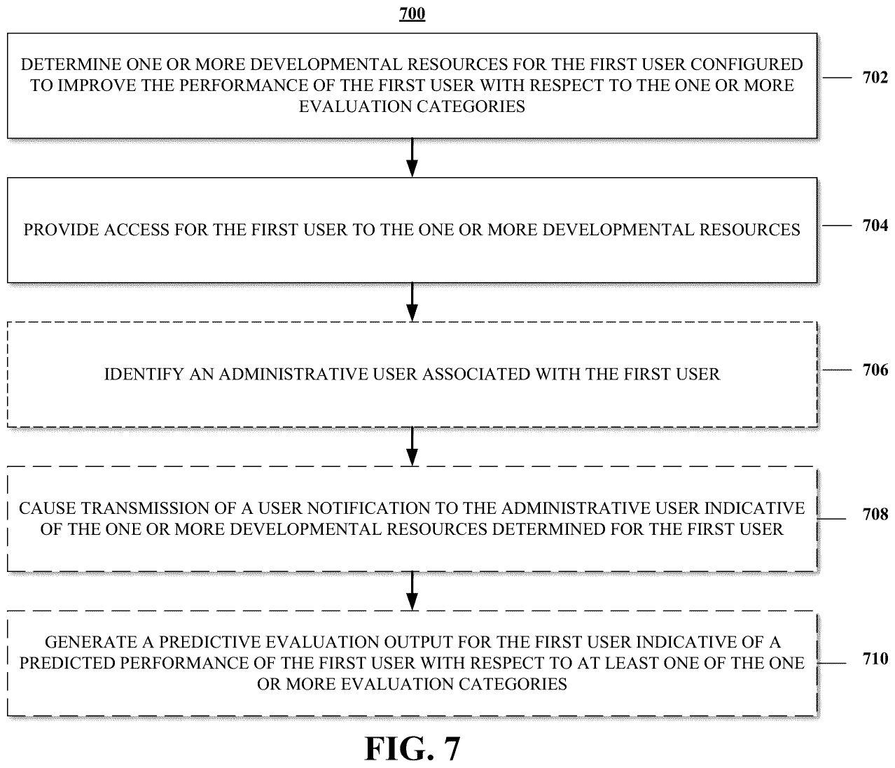

FIG. 7 illustrates a flowchart containing a series of operations for developmental resource provisioning (e.g., method 700). The operations illustrated in FIG. 7 may, for example, be performed by, with the assistance of, and/or under the control of an apparatus (e.g., server 200), as described above. In this regard, performance of the operations may invoke one or more of the processor 202, memory 206, communication interface 204, and/or data evaluation circuitry 208.

As shown in operation 702, the apparatus (e.g., server 200) may include means, such as the processor 202, or the like, for determining one or more developmental resources for the first user associated with the one or more evaluation categories. As described herein, the evaluation attributes and outcomes for the first user may be indicative of the performance of the first user with respect to one or more evaluation categories (e.g., new business development, wealth management, client service, and/or practice management). In an instance in which the relative performance of the first user may be improved, the server 200 may determine one or more developmental resources configured to improve the performance of the first user with respect to the one or more evaluation categories. By way of example, the developmental resources may include articles, seminars, videos, consultations, publications, etc. that, when reviewed or completed by the first user, may result in improvement of the first user with respect to particular evaluation categories. By way of a non-limiting example, the first user may receive an evaluation output indicating that performance with regard to a new business development evaluation category may be improved. Developmental resources related to referral codes, marketing, referral pipelines, and/or the like may be determined for the first user, such as illustrated in FIG. 9.

Thereafter, as shown in operation 704, the apparatus (e.g., server 200) may include means, such as the processor 202 or the like, for providing access for the first user to the one or more developmental resources. In some embodiments, the first user and associated first user device 102 may not have access to a particular set of developmental resources prior to generation of an evaluation output. By way of example, an entity associated with the first user may require that the first user complete the operations of FIG. 3 before providing access to particular developmental resources to the first user. In this way, the entity may operate to selectively target particular developmental resources to specific users based upon need (e.g., which resources will most benefit the given user considering the user's evaluation output), thereby reducing subscription costs, computational or processing burden of the server, and/or the like.

In some embodiments, as shown in operations 706 and 708, the apparatus (e.g., server 200) may include means, such as the processor 202 or the like, for identifying an administrative user associated with the first user and causing transmission of a user notification to the administrative user indicative of the one or more developmental resources determined for the first user, respectively. As described above, in some instances the administrative user may be a manager of a team, group, or the like that includes the first user, and the administrative user may assign the first user to participate in an evaluation with respect to financial related evaluation categories. In such embodiments, the administrative user may, at least in part, impact access to the developmental resources provided to the first user. For example, a plurality of developmental resources may be displayed to the administrative user (e.g., via an administrative dashboard or the like), and the administrative user (e.g., via the administrative user device 106) may selectively provide access for the first user device 102 to particular developmental resources. In this way the administrative user may also monitor the progress of the first user with respect to the developmental resources provided and/or may determine based on personal knowledge of the first user and/or other relevant users which developmental resources would be most beneficial for improving the performance of the first user.

In some embodiments, as shown in operation 710, the apparatus (e.g., server 200) may include means, such as the processor 202 or the like, for generating a predictive evaluation output for the first user indicative of a predicted performance of the first user with respect to at least one of the one or more evaluation categories following completion of the one or more developmental resources. As described above, the developmental resources may be configured to improve the performance of users with respect to the one or more evaluation categories. As a user completes the developmental resources and the server 200 further generates updated evaluation attributes and outputs, the server 200 may determine improvements that are attributable to particular developmental resources. By way of a non-limiting example, the server 200 may determine that users that complete a first developmental resource improve their performance with respect to a particular evaluation category by a defined amount (e.g., a percentage improvement, an average user ranking difference, etc.). As such, the server 200 may, in some embodiments, generate a predictive evaluation output for the first user following completion of one or more developmental resources. Furthermore, in some embodiments, the server 200 may operate to prioritize or select particular developmental resources for providing to users based upon the improvement associated with or attributable to the particular developmental resources.

With reference to FIGS. 8A-8B, example presentations of input objects are illustrated. As shown in FIG. 8A, a user interface 800 may include a plurality of input objects 802 by which the user may provide one or more user inputs. In FIG. 8A, a plurality of input objects 802 are illustrated that allow an associated user to select one or more of the input objects so as to indicate a positive or affirmative response. In contrast, for input objects 802 that are not selected by the user, such a lack of selection may be indicative of negative or contrary response. Additionally or alternatively, as shown in FIG. 8B, a user interface 804 may include a plurality of input objects 806 by which the user is able to provide associated free text or open responses. Although illustrated in FIG. 8B with open responses that allow for the user to input applicable percentages, the present disclosure contemplates that the input objects 806 may be configured to receive any free text input based on the intended application of the system 100. The present disclosure contemplates that the user input objects 802, 806 may include any mechanism for receiving a user input based upon the intended application of the system 100.

As described above, the server 200 may operate to present the user input objects 802, 806 to the first user in an arrangement that is personalized to the first user (e.g., a personalized interface and/or interactive experience). In such an embodiment, the presentation parameters determined by the server 200 or by the entity associated with the first user may define a configuration by which the user input objects 802, 806 are presented to the first user. For example, the positioning of user input objects 802, 806 in the respective user interfaces 802, 804, the orientation of user input objects 802, 806, the relative positioning between user input objects 802, 806, the selection of certain user input objects 802, 806 for presentation and/or the exclusion of other, the sequence or chronology for presentation of the user input objects, and/or the like within the user interfaces 800, 804. By way of an additional example, the presentation parameters may define the style, color, animation, transitions, etc. used by the user interface to display the one or more user input objects.

As described above, the presentation of the input objects 802, 806 may be dynamic based on the actions by the first user and/or in response to actions (e.g., user inputs) by other users (e.g., an example second user). With continued reference to FIGS. 8A-8B, for example, the time at which the user interface 800 is presented to the first user (e.g., a first time) and the time at which the user interface 804 is presented to the first user (e.g., a second time) may vary based on the particular user or other users. For example, in some embodiments, user interface 800 may be presented to the first user prior in time to the presentation of user interface 804. For a second user, however, user interface 804 may be presented prior in time to the presentation of user interface 800. In some embodiments, the determination of the presentation order may occur in real-time, such as in instances in which the first user and the second user are performing the indexing and evaluation operations of the system 100. By way of an additional example, the ordering of the input objects 802, 806 within the respective user interfaces 800, 804 may also be user-specified and/or dynamic. For example, the ordering of the input objects 802 for the first user may differ from the ordering of input objects 802 for the second user and, in some embodiments, this ordering may dynamically change during presentation of the user interfaces 800, 806.

With reference to FIG. 9 an example evaluation output 900 and associated developmental resources 902 are illustrated. As shown, the evaluation output 900, provided via user interface or the like, may be indicative of a performance of the first user with respect to at least the one or more evaluation categories. The evaluation output 900 may provide a summary of the first user's performance, as defined by the evaluation attributes, with respect to the one or more evaluation categories. As above, the present disclosure contemplates that the arrangement, orientation, configuration, etc. of such a user interface providing the generated evaluation output 900 may vary based upon the intended application of the system 100, the capabilities or functionality of the first user device 102, and/or the like. Although described herein with reference to an example evaluation output 900 for a first user, the present disclosure contemplates that an evaluation output for any number of other users (e.g., at least a second user) accessing the application(s) may be provided by the server 200.

As described above, the one or more user inputs of the first user associated with a particular evaluation category may be compared with evaluation attributes (e.g., generated based upon the user inputs of other users) associated with the same evaluation category to generate the evaluation output 900. This comparison may provide the performance of the first user relative the plurality of other users with respect to this particular evaluation category. The evaluation attribute of the first user in such an embodiment may be represented as a ranking of the first user or the like (e.g., greater than 50% of other users, in the top 25% of all users, etc.). In some embodiments, the comparison may occur on the user input object level in that each user's input to a particular user input object (e.g., a first user input object) may be compared, and the evaluation attribute for the first user may indicate the performance of the first user relative to other users with regard to the first user input object alone.

With continued reference to FIG. 9, one or more developmental resources 902 for the first user associated with the one or more evaluation categories are shown. As described above, the evaluation attributes and outcomes for the first user may be indicative of the performance of the first user with respect to one or more evaluation categories (e.g., new business development, wealth management, client service, and/or practice management). In an instance in which the relative performance of the first user may be improved, the server 200 may determine one or more developmental resources 902 configured to improve the performance of the first user with respect to the one or more evaluation categories. By way of example, the developmental resources may include articles, seminars, videos, consultations, publications, etc. that, when reviewed or completed by the first user, may result in improvement of the first user with respect to particular evaluation categories. By way of a non-limiting example, the first user may receive an evaluation output 900 indicating that performance with regard to a new business development evaluation category may be improved. Developmental resources 902 related to referral codes, marketing, referral pipelines, and/or the like may be determined for the first user.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components may be used in conjunction with the system. Therefore, it is to be understood that the inventions are not to be limited to the specific embodiments disclosed and that modifications and other embodiments are intended to be included within the scope of the appended claims. Moreover, the steps in the method described above may not necessarily occur in the order depicted in the accompanying diagrams, and in some cases one or more of the steps depicted may occur substantially simultaneously, or additional steps may be involved. Although specific terms are employed herein, they are used in a generic and descriptive sense only and not for purposes of limitation.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. The disclosed embodiments relate primarily to a network interface environment, however, one skilled in the art may recognize that such principles may be applied to any scheduler receiving commands and/or transactions and having access to two or more processing cores. Alternative embodiments that result from combining, integrating, and/or omitting features of the embodiment(s) are also within the scope of the disclosure. Accordingly, the scope of protection is not limited by the description set out above.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure. Use of broader terms such as “comprises,” “includes,” and “having” should be understood to provide support for narrower terms such as “consisting of,” “consisting essentially of,” and “comprised substantially of” Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

1. A computer-implemented method for data indexing and evaluation in distributed computing environments, the method comprising:
receiving a request for data evaluation associated with a first user;
generating one or more user input objects based upon the request, wherein the one or more user input objects are associated with one or more evaluation categories;
causing presentation of the one or more user input objects to the first user;
receiving one or more user inputs from the first user via the one or more user input objects;
determining one or more evaluation attributes associated with the first user based on the received one or more user inputs; and
generating an evaluation output indicative of a performance of the first user with respect to at least the one or more evaluation categories.

2. The computer-implemented method according to claim 1, wherein the request for data evaluation further comprises one or more first user characteristics of the first user, and wherein generating the one or more user input objects is further based upon the one or more first user characteristics.

3. The computer-implemented method according to claim 2, wherein the one or more evaluation categories are selected at least partially based upon the one or more first user characteristics.

4. The computer-implemented method according to claim 1, further comprising determining one or more presentation parameters that define a configuration by which the user input objects are presented to the first user.

5. The computer-implemented method according to claim 4, wherein the one or more presentation parameters comprise a presentation order defining an order in which the one or more user input objects are presented to the user.

6. The computer-implemented method according to claim 1, wherein the one or more user input objects further comprise at least a first user input object presented to the first user at a first time and a second user input object presented to the first user at a second time, the method further comprising determining the first time and the second time based at least in part upon the user input from the first user provided via the first user input object.

7. The computer-implemented method according to claim 6, wherein each of the first user input object and the second user input object is associated with a first evaluation category.

8. The computer-implemented method according to claim 1, wherein the one or more user input objects further comprise at least:
a first user input object associated with a first evaluation category; and
a second user input object associated with a second evaluation category.

9. The computer-implemented method according to claim 1, wherein determining one or more evaluation attributes associated with the first user with respect to the one or more evaluation categories further comprises:
accessing a database storing a plurality of evaluation outputs generated based upon one or more evaluation attributes associated with a plurality of users;
comparing the one or more user inputs received from the first user associated with the first user with the plurality of evaluation outputs associated with the plurality of users; and
determining the one or more evaluation attributes associated with the first user based upon the comparison.

10. The computer-implemented method according to claim 1, wherein determining one or more evaluation attributes associated with the first user with respect to the one or more evaluation categories further comprises:
training a machine learning model on a plurality of evaluation outputs generated based upon one or more evaluation attributes associated with a plurality of users; and
deploying the trained machine learning model on the one or more user inputs from the first user to generate the one or more evaluation attributes of the first user.

11. The computer-implemented method according to claim 1, wherein the evaluation output of the first user is generated at a first time, the method further comprising:
receiving an evaluation output associated with a second user at a second time that is later in time than the first time; and
modifying the evaluation output of the first user in response to the evaluation output of the second user.

12. The computer-implemented method according to claim 1, wherein the evaluation output of the first user is iteratively updated in response to iterative generation of evaluation outputs associated with a plurality of users other than the first user.

13. The computer-implemented method according to claim 1, further comprising:
determining one or more developmental resources for the first user associated with the one or more evaluation categories, wherein the one or more developmental resources are configured to improve the performance of the first user with respect to the one or more evaluation categories; and
providing access for the first user to the one or more developmental resources.

14. The computer-implemented method according to claim 13, further comprising:
identifying an administrative user associated with the first user; and
causing transmission of a user notification to the administrative user indicative of the one or more developmental resources determined for the first user.

15. The computer-implemented method according to claim 13, further comprising generating a predictive evaluation output for the first user indicative of a predicted performance of the first user with respect to at least one of the one or more evaluation categories following completion of the one or more developmental resources.

16. A system comprising:
a non-transitory storage device; and
a processor coupled to the non-transitory storage device, wherein the processor is configured to:
receive a request for data evaluation associated with a first user;
generate one or more user input objects based upon the request, wherein the one or more user input objects are associated with one or more evaluation categories;
cause presentation of the one or more user input objects to the first user;
receive one or more user inputs from the first user via the one or more user input objects;
determine one or more evaluation attributes associated with the first user based on the received one or more user inputs; and
generate an evaluation output indicative of a performance of the first user with respect to at least the one or more evaluation categories.

17. The system according to claim 16, wherein, in determining the one or more evaluation attributes associated with the first user with respect to the one or more evaluation categories, the processor is further configured to:
access a database storing a plurality of evaluation outputs generated based upon one or more evaluation attributes associated with a plurality of users;
compare the one or more user inputs received from the first user associated with the first user with the plurality of evaluation outputs associated with the plurality of users; and
determine the one or more evaluation attributes associated with the first user based upon the comparison.

18. The system according to claim 16, wherein, in determining the one or more evaluation attributes associated with the first user with respect to the one or more evaluation categories, the processor is further configured to:
train a machine learning model on a plurality of evaluation outputs generated based upon one or more evaluation attributes associated with a plurality of users; and
deploy the trained machine learning model on the one or more user inputs from the first user to generate the one or more evaluation attributes of the first user.

19. A computer program product comprising at least one non-transitory computer-readable storage medium having computer program code thereon that, in execution with at least one processor, configures the computer program product for:
receiving a request for data evaluation associated with a first user;
generating one or more user input objects based upon the request, wherein the one or more user input objects are associated with one or more evaluation categories;
causing presentation of the one or more user input objects to the first user;
receiving one or more user inputs from the first user via the one or more user input objects;
determining one or more evaluation attributes associated with the first user based on the received one or more user inputs; and
generating an evaluation output indicative of a performance of the first user with respect to at least the one or more evaluation categories.

20. The computer program product according to claim 19, wherein, in determining the one or more evaluation attributes associated with the first user with respect to the one or more evaluation categories, the computer program product is further configured for:
accessing a database storing a plurality of evaluation outputs generated based upon one or more evaluation attributes associated with a plurality of users;
comparing the one or more user inputs received from the first user associated with the first user with the plurality of evaluation outputs associated with the plurality of users; and
determining the one or more evaluation attributes associated with the first user based upon the comparison.
